(19) United States
(12) Patent Application Publication
(10) Pub. No.: US 2025/0154313 A1
(43) Pub. Date: May 15, 2025

(54) POLYMER, RESIN COMPOSITION, ARTICLE COMPRISING THE SAME, AND PREPARATION METHOD THEREOF

(71) Applicant: ELITE ELECTRONIC MATERIAL (KUNSHAN) CO., LTD., Kunshan City (CN)

(72) Inventors: Yahui MA, Kunshan City (CN); Rongtao WANG, Kunshan City (CN); Diya LIU, Kunshan City (CN)

(73) Assignee: ELITE ELECTRONIC MATERIAL (KUNSHAN) CO., LTD., Kunshan City (CN)

(21) Appl. No.: 18/435,724

(22) Filed: Feb. 7, 2024

(30) Foreign Application Priority Data
Nov. 9, 2023 (CN) 202311489448.X

(51) Int. Cl. C08G 61/02; C08J 5/24; C08L 65/00; C08L 71/12

(52) U.S. Cl. CPC C08G 61/02; C08J 5/24; C08L 65/00; C08L 71/126; C08J 2465/00; C08L 2203/16; C08L 2203/20

(57) ABSTRACT

A polymer is disclosed, having a structure represented by Formula (1), wherein in Formula (1), X is adamantyl group, each of R₁-R₄ is independently hydrogen atom or C1-C3 alkyl group, and n is an integer of 2-50. A resin composition is also disclosed, comprising: (A) an unsaturated carbon-carbon double bond-containing polyphenylene ether resin, and (B) the above polymer. In addition, an article made from the above polymer or the above resin composition is also disclosed. The article comprises a prepreg, a resin film, a laminate or a printed circuit board and has improvements in one or more of the following properties: glass transition temperature, T300 thermal resistance, percent thermal expansion at Z-axis, dissipation factor, dissipation factor variation rate under moisture and heat, dissipation factor variation rate under heat and water absorption rate.

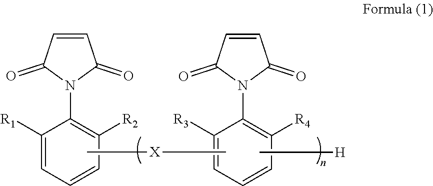

### CROSS-REFERENCE TO RELATED APPLICATIONS

This non-provisional application claims priority under 35 U.S.C. § 119(a) on Patent Application No. 202311489448.X filed in China on Nov. 9, 2023, the entire contents of which are hereby incorporated by reference.

### BACKGROUND

### 1. Technical Field

This disclosure relates to a polymer, resin composition comprising the same and an article made from the polymer or the resin composition, specifically a polymer or a resin composition applicable to a prepreg, a resin film, a laminate and a printed circuit board.

### 2. Related Art

Recently, with the development of electronic products toward multifunction, high performances and various application scenarios, the performances required of printed circuit boards equipped with electronic components have become increasingly extensive and advanced. For instance, with an increasing number of electronic components equipped thereon and an increasing signal transmission speed, thermal resistance and dielectric properties of printed circuit boards also need to be improved. For instance, with the popularization of electronic products in outdoor environments, especially high temperature and high humidity, the reliability of printed circuit boards also needs to be optimized.

Maleimide resins have excellent thermal properties, mechanical properties and corrosion resistance, and serve as high-performance resins widely used in manufacturing printed circuit boards. However, the conventional maleimide resin has poor solubility and is hygroscopic, which greatly limits the improvement of printed circuit board performances. Currently, modifications to the conventional maleimide resin to improve their properties have been tried. Adamantane has a large diamond-like cage structure, and the special molecular structure thereof gives excellent properties such as high thermal stability, antioxidant properties and fat solubility so that adamantane has gradually attracted people's attention and been introduced into many polymers to improve the properties of polymers. The present disclosure is intended to provide a novel polymer and a resin composition thereof, expecting an article thereof simultaneously has high glass transition temperature and T300 thermal resistance, and low percent thermal expansion at Z-axis, dissipation factor, dissipation factor variation rate under moisture and heat, dissipation factor variation rate under heat and water absorption rate.

### SUMMARY

In view of the above problems in the prior arts, specifically, the current material is unable to meet one or more of the above performance demands, the main purpose of the present disclosure is to provide a polymer or a resin composition, an article made from the polymer or the resin composition and a preparation method of the polymer to solve at least one of the above problems.

In the first aspect, the present disclosure provides a polymer, having a structure represented by Formula (1):

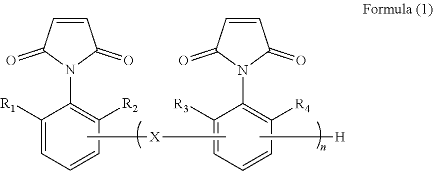

wherein in Formula (1), X is adamantyl group, each of R₁-R₄ is independently hydrogen atom or C1-C3 alkyl group, and n is an integer of 2-50.

For instance, in one exemplary embodiment, X is monoadamantyl group, diamantyl group or polyamantyl group.

For instance, in one exemplary embodiment, the polymer represented by Formula (1) comprises a polymer represented by Formula (1-1), a polymer represented by Formula (1-2), a polymer represented by Formula (1-3) or a combination thereof:

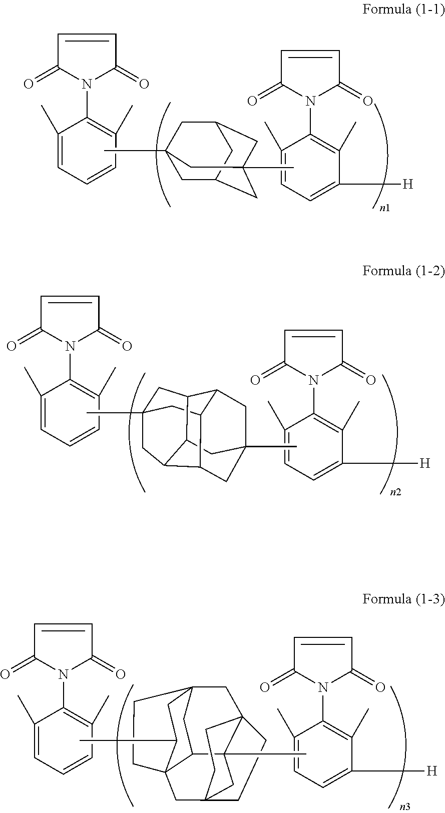

wherein each of n1-n3 is independently an integer of 2-50.

For instance, in one exemplary embodiment, the polymer has a number average molecular weight of 800-17000.

In the second aspect, the present disclosure provides a resin composition comprising:
(A) an unsaturated carbon-carbon double bond-containing polyphenylene ether resin, and
(B) the above polymer.

For instance, in one exemplary embodiment, with respect to 100 parts by weight of the unsaturated carbon-carbon double bond-containing polyphenylene ether resin, the amount of the polymer is 10-80 parts by weight.

For instance, in one exemplary embodiment, with respect to 100 parts by weight of the unsaturated carbon-carbon double bond-containing polyphenylene ether resin, the amount of the polymer is 20-70 parts by weight.

For instance, in one exemplary embodiment, the unsaturated carbon-carbon double bond-containing polyphenylene ether resin comprises a (meth)acryloyl group-containing polyphenylene ether resin, a vinylbenzyl group-containing polyphenylene ether resin, a vinyl group-containing polyphenylene ether resin or a combination thereof.

For instance, in one exemplary embodiment, the resin composition further comprises an unsaturated carbon-carbon double bond-containing crosslinking agent, for instance, in one exemplary embodiment, the unsaturated carbon-carbon double bond-containing crosslinking agent is bis(vinylphenyl)ethane, bis(vinylbenzyl)ether, divinylbenzene, divinylnaphthalene, divinylbiphenyl, triallyl isocyanurate, triallyl cyanurate, vinylbenzocyclobutene, trivinyl cyclohexane, diallyl bisphenol A, butadiene, decadiene, octadiene, two or more-functional acrylate or a combination thereof.

For instance, in one exemplary embodiment, the resin composition further comprises a polyolefin, an organic silicone resin, a benzoxazine resin, an epoxy resin, a polyester resin, a phenol resin, an amine curing agent, a polyamide, a polyimide, a styrene maleic anhydride, a maleimide resin other than the polymer represented by Formula (1), a cyanate ester resin, a maleimide triazine resin or a combination thereof.

For instance, in one exemplary embodiment, the resin composition further comprises a curing accelerator, a polymerization inhibitor, a flame retardant, an inorganic filler, a surfactant, a coloring agent, a toughening agent, a solvent or a combination thereof.

In the third aspect, the present disclosure provides an article made from the above polymer or the above resin composition, and the article comprises a prepreg, a resin film, a laminate or a printed circuit board.

For instance, in one exemplary embodiment, the article has one or more of the following properties:
a glass transition temperature as measured by reference to IPC-TM-650 2.4.24.4 of greater than or equal to 269° C.;
a T300 thermal resistance as measured by reference to IPC-TM-650 2.4.24.1 of greater than 70 minutes;
a percent thermal expansion at Z-axis as measured by reference to IPC-TM-650 2.4.24.5 of less than or equal to 1.2%;
a dissipation factor at 10 GHz as measured by reference to JISC2565 of less than or equal to 0.0018;
a dissipation factor variation rate under moisture and heat of less than or equal to 8%, calculated by a dissipation factor of the article placed at room temperature and a dissipation factor of the article placed at a temperature of 85° C. and a relative humidity of 85% for 120 hours respectively at 10 GHz as measured by reference to JISC2565;
a dissipation factor variation rate under heat of less than or equal to 8%, calculated by a dissipation factor of the article placed at room temperature and a dissipation factor of the article placed at a temperature of 125° C. for 120 hours respectively at 10 GHz as measured by reference to JISC2565;
a water absorption rate as measured by reference to IPC-TM-650 2.6.2.1 and IPC-TM-650 2.6.16.1 of less than or equal to 0.25%.

In the fourth aspect, the present disclosure provides a preparation method of the above polymer, comprising: firstly, mixing and reacting an aniline and/or its derivative and a dihalogen-substituted adamantane in a reaction vessel to obtain an intermediate product; and then adding a maleic anhydride to the reaction vessel containing the intermediate product to obtain the polymer.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a FTIR spectrum of Polymer P1 of one exemplary embodiment.

### DETAILED DESCRIPTION

All technical and scientific terms used herein have the common meaning as understood by those skilled in the art. Unless otherwise set forth in the specification, the terms defined herein shall prevail.

The terms “comprise,” “include,” “contain,” “have,” or the like belongs to open-ended transitional phrase (i.e., other elements not listed herein may be contained). The terms “consisting of,” “composed by,” “remainder being,” or the like belongs to close-ended transitional phrases.

For the convenience of the description, numerical ranges used herein shall be understood as including all of the possible subranges and individual numerals or values therein, including integers and fractions.

The value used herein includes all of the values which will be the same as such value after being rounded off.

It should be understood that members in the Markush group can individually or combinedly be used to describe the present disclosure.

The derivative used herein refers to the product in which a hydrogen atom or atomic group therein is substituted by another atom or atomic group.

A polymer used herein refers to the product formed by monomer(s) via polymerization. A polymer may include a homopolymer (also known as a self-polymer), a copolymer, a prepolymer, etc., but the present disclosure is not limited thereto. The homopolymer refers to the polymer formed by a single monomer via polymerization. The copolymers include: random copolymers, such as a structure of -AABABBBAAABBA-); alternating copolymers, such as a structure of -ABABABAB-; graft copolymers, such as a structure of -AA(A-BBBB)AA(A-BBBB)AAA-; and block copolymers, such as a structure of -AAAAA-BBBBBB-AAAAA-. For instance, a styrene-butadiene copolymer disclosed herein includes a styrene-butadiene random copolymer, a styrene-butadiene alternating copolymer, a styrene-butadiene graft copolymer, a styrene-butadiene block copolymer or a combination thereof. The prepolymer refers to a polymer having a lower molecular weight between the molecular weight of the monomer and the molecular weight of the final polymer, and a prepolymer contains a reactive functional group capable of participating further polymerization to obtain the final polymer product which has been fully crosslinked or cured. The term “polymer” includes an oligomer. The oligomer refers to a polymer with 2 to 20, typically 2 to 5, repeating units, but the present disclosure is not limited thereto.

The term “resin” used herein includes monomer, polymer thereof, a combination of the monomer, a combination of the polymer, or a combination of the monomer and the polymer, but the present disclosure is not limited thereto.

A modification described herein includes a modification includes a product derived from a resin with its reactive functional group modified, a product derived from a prepolymerization reaction of each resin and other resins, a product derived from copolymerizing each resin and other resins, a product derived from crosslinking reaction of each resin and other resins or the like.

The unsaturated bonds used herein refer to reactive unsaturated bonds (e.g., unsaturated bonds capable of carrying out crosslinking reaction with other functional groups), but the present disclosure is not limited thereto.

The unsaturated carbon-carbon double bond herein preferably includes a vinyl group, a vinylbenzyl group, a (meth)acryloyl group, an allyl group or a combination thereof, but the present disclosure is not limited thereto. The vinyl group encompass a vinyl group and a vinylene group. The (meth)acryloyl group encompass an acryloyl group and a methacryloyl group.

An alkyl group, an alkenyl group and a monomer described herein encompass various isomers thereof. For instance, a propyl group encompass n-propyl and iso-propyl.

The term “part(s) by weight” represents relative weight part(s) in the composition in any weight unit, such as kilogram, gram, pound and the like, but the present disclosure is not limited thereto. For instance, 100 parts by weight of the unsaturated carbon-carbon double bond-containing polyphenylene ether resin may represent 100 kilograms of the unsaturated carbon-carbon double bond-containing polyphenylene ether resin or 100 pounds of the unsaturated carbon-carbon double bond-containing polyphenylene ether resin.

It should be understood that as long as there is no contradiction, each of the features of the exemplary embodiments described herein may be individually or combinedly combined with each other.

It should be understood that the exemplary embodiments described herein are exemplary in all aspects and are not intended to limit the scope of the present disclosure. Therefore, the scope of the present disclosure is not limited to the exemplary embodiments.

The present disclose provides a polymer, having a structure represented by Formula (1):

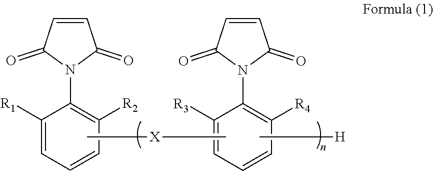

wherein in Formula (1), X is adamantyl group, each of R₁-R₄ is independently hydrogen atom or C1-C3 alkyl group, and n is an integer of 2-50.

For instance, in one exemplary embodiment of the present disclosure, X is monoadamantyl group, diamantyl group or polyamantyl group.

For instance, in one exemplary embodiment of the present disclosure, the polymer represented by Formula (1) includes a polymer represented by Formula (1-1), a polymer represented by Formula (1-2), a polymer represented by Formula (1-3) or a combination thereof:

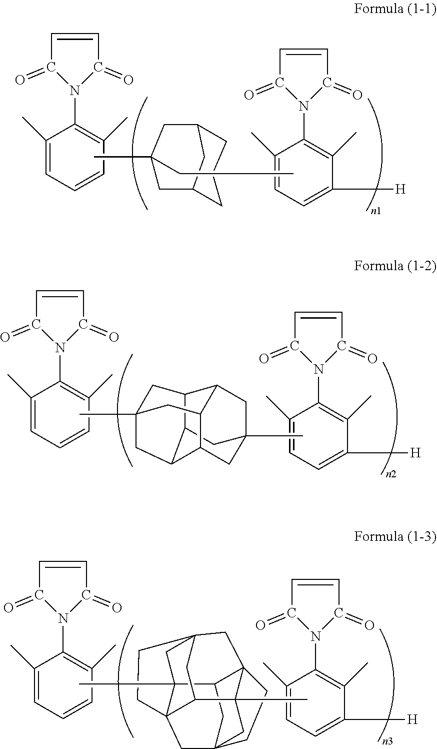

wherein each of n1-n3 is independently an integer of 2-50.

For instance, in one exemplary embodiment of the present disclosure, the polymer has a number average molecular weight of 800-17000. Preferably, the polymer represented by Formula (1) has a number average molecular weight of 800-8000.

The polymer represented by Formula (1) disclosed herein may be prepared in various ways known to this field.

For instance, in one exemplary embodiment of the present disclosure, the polymer represented by Formula (1) may be prepared by the following method, including: firstly, mixing and reacting an aniline and/or its derivative and a dihalogen-substituted adamantane in a reaction vessel to obtain an intermediate product; and then adding a maleic anhydride to the reaction vessel containing intermediate product to obtain the polymer.

Specifically, the method includes the following steps:

Step (1): an aniline derivative and a dihalogen-substituted adamantane are added in a reaction vessel, heated to 80-130° C. and reacted for 2-4 hours, then raised to 180-230° C. and reacted for 3-24 hours, and then cooled to room temperature, and a base solution is added thereto, thereby obtaining an intermediate product;

Step (2): a maleic anhydride, a solvent and the above intermediate product are added to a reaction vessel and reacted at room temperature for 2-4 hours, and a dehydration catalyst is added thereto, raised to 50-70° C. and reacted for 2-8 hours, thereby obtaining the polymer represented by Formula (1).

In Step (1), the aniline derivative includes 2,6-dimethylaniline, 2-methylaniline or 2,6-diethylaniline, but the present disclosure is not limited thereto.

In Step (1), the dihalogen-substituted adamantane includes a dibromo-substituted monoadamantane, a dibromo-substituted diamantane or a dibromo-substituted polyamantane, but the present disclosure is not limited thereto.

In Step (1), the base solution includes inorganic base solution or organic base solution, the inorganic base solution includes sodium hydroxide (NaOH) aqueous solution, potassium hydroxide (KOH) aqueous solution, and the organic base solution includes triethylamine aqueous solution, but the present disclosure is not limited thereto.

In Step (2), the solvent includes acetone, butanone or a combination thereof, but the present disclosure is not limited thereto.

In Step (2), the dehydration catalyst is composed of triethylamine, acetic anhydride and metal acetate, and the metal acetate includes magnesium acetate or nickel acetate, but the present disclosure is not limited thereto.

The present disclose provides resin composition, including:
(A) an unsaturated carbon-carbon double bond-containing polyphenylene ether resin, and
(B) the above polymer.

For instance, in one exemplary embodiment of the present disclosure, in the resin composition, with respect to 100 parts by weight of the unsaturated carbon-carbon double bond-containing polyphenylene ether resin, the amount of the polymer represented by Formula (1) is 10-80 parts by weight. Preferably, in the resin composition, with respect to 100 parts by weight of the unsaturated carbon-carbon double bond-containing polyphenylene ether resin, the amount of the polymer represented by Formula (1) is 20-70 parts by weight.

In the resin composition of the present disclosure, the amount of each component is based on a total amount of the unsaturated carbon-carbon double bond-containing polyphenylene ether resin being 100 parts by weight, for instance, with respect to 100 parts by weight of the unsaturated carbon-carbon double bond-containing polyphenylene ether resin, the amount of the polymer represented by Formula (1) may be 10, 15, 20, 25, 30, 35, 40, 45, 50, 55, 60, 65, 70, 75 or 80 parts by weight, but the present disclosure is not limited thereto.

The unsaturated carbon-carbon double bond-containing polyphenylene ether resin suitable for the present disclosure is not particularly limited and may be any one or more of the unsaturated carbon-carbon double bond-containing polyphenylene ether resins suitable for manufacturing a prepreg, a resin film, a laminate or a printed circuit board, and may be any one or more of commercial products, self-made products or a combination thereof, for instance, (meth)acryloyl group-containing polyphenylene ether resin, vinylbenzyl group-containing polyphenylene ether resin, vinyl group-containing polyphenylene ether resin or a combination thereof, but the present disclosure is not limited thereto.

The unsaturated carbon-carbon double bond-containing polyphenylene ether resins used in the present disclosure all have unsaturated carbon-carbon double bonds and a phenylene ether skeleton, wherein the unsaturated carbon-carbon double bond is a reactive group which may perform self-polymerization under heat and may also perform free radical polymerization with other components containing an unsaturated bond in the resin composition and finally result in crosslinking and curing. The cured product thereof has high thermal resistance and good dielectric properties. Preferably, the unsaturated carbon-carbon double bond-containing polyphenylene ether resin includes an unsaturated carbon-carbon double bond-containing polyphenylene ether resin with 2,6-dimethyl substitution in its phenylene ether skeleton, wherein the methyl groups form steric hindrance to prevent the oxygen atom of the ether group from forming a hydrogen bond or Van der Waals force to absorb moisture, thereby achieving better dielectric properties.

In some exemplary embodiments, the unsaturated carbon-carbon double bond-containing polyphenylene ether resin may include a (meth)acryloyl group-containing polyphenylene ether resin with a number average molecular weight of about 1900 to 2300 (such as SA9000, available from Sabic), a vinylbenzyl group-containing polyphenylene ether resin with a number average molecular weight of about 1200 (such as OPE-2st 1200, available from Mitsubishi Gas Chemical Co., Inc.), a vinylbenzyl group-containing polyphenylene ether resin with a number average molecular weight of about 2200 (such as OPE-2st 2200, available from Mitsubishi Gas Chemical Co., Inc.), a vinylbenzyl group-containing polyphenylene ether resin with a number average molecular weight of about 2400 to 2800 (such as vinylbenzyl group-containing bisphenol A polyphenylene ether resin), a vinyl group-containing polyphenylene ether resin with a number average molecular weight of about 2200 to 3000 or a combination of the aforementioned resins, but the present disclosure is not limited thereto. Among them, the vinyl group-containing polyphenylene ether resin may include various polyphenylene ether resins disclosed in the US Patent Application Publication No. 20160185904A1, all of which are incorporated herein by reference in their entirety. Among them, the vinylbenzyl group-containing polyphenylene ether resin may include a vinylbenzyl group-containing biphenyl polyphenylene ether resin, a vinylbenzyl group-containing bisphenol A polyphenylene ether resin or a combination thereof, but the present disclosure is not limited thereto.

For instance, in one exemplary embodiment of the present disclosure, an unsaturated carbon-carbon double bond-containing crosslinking agent may be further added to the resin composition as needed, and the unsaturated carbon-carbon double bond-containing crosslinking agent may be various unsaturated carbon-carbon double bond-containing crosslinking agents known in this field. The specific examples may include bis(vinylphenyl)ethane, bis(vinylbenzyl)ether, divinylbenzene, divinylnaphthalene, divinylbiphenyl, triallyl isocyanurate, triallyl cyanurate, vinylbenzocyclobutene, trivinyl cyclohexane, diallyl bisphenol A, butadiene, decadiene, octadiene, two or more-functional acrylate or a combination thereof.

The two or more-functional acrylate may include various bifunctional acrylates, trifunctional acrylates, tetrafunctional acrylates or more functional acrylates known in this field and may be available from SHIN-NAKAMURA CHEMICAL Co, Ltd., KYOEISHA CHEMICAL Co., Ltd., Nippon Kayaku Co., Ltd. or Sartomer. The specific examples may include diallyl isophthalate (DAIP), dioxanediol diacrylate, tricyclodecane dimethanol diacrylate, tricyclodecane dimethanol dimethacrylate or a combination thereof, but the present disclosure is not limited thereto.

The amount of the unsaturated carbon-carbon double bond-containing crosslinking agent used in the present disclosure may be adjusted as needed, for instance, with respect to 100 parts by weight of the unsaturated carbon-carbon double bond-containing polyphenylene ether resin, the amount of the unsaturated carbon-carbon double bond-containing crosslinking agent may be 1 to 30 parts by weight, preferably 5 to 20 parts by weight, such as 5 parts by weight, 10 parts by weight, 15 parts by weight or 20 parts by weight, but the present disclosure is not limited thereto.

For instance, in one exemplary embodiment of the present disclosure, a polyolefin, an organic silicone resin, a benzoxazine resin, an epoxy resin, a polyester resin, a phenol resin, an amine curing agent, a polyamide, a polyimide, a styrene maleic anhydride, a maleimide resin other than the polymer represented by Formula (1), a cyanate ester resin, a maleimide triazine resin or a combination thereof may be further added to the resin composition as needed.

In the resin composition of the present disclosure, with respect to 100 parts by weight of the unsaturated carbon-carbon double bond-containing polyphenylene ether resin, the amount of the polyolefin, the organic silicone resin, the benzoxazine resin, the epoxy resin, the polyester resin, the phenol resin, the polyamide, the polyimide, the styrene maleic anhydride, the maleimide resin other than the polymer represented by Formula (1), the cyanate ester resin or the maleimide triazine resin is not particularly limited, and the amount of each component may be independently 1 part by weight to 100 parts by weight, such as 1 part by weight, 10 parts by weight, 15 parts by weight, 20 parts by weight, 25 parts by weight, 50 parts by weight or 100 parts by weight, but the present disclosure is not limited thereto. With respect to 100 parts by weight of the unsaturated carbon-carbon double bond-containing polyphenylene ether resin, the amount of the amine curing agent is also not particularly limited, for instance, may be 1 to 15 parts by weight, such as 1 part by weight, 4 parts by weight, 7.5 parts by weight, 12 parts by weight or 15 parts by weight, but the present disclosure is not limited thereto.

For instance, in one exemplary embodiment of the present disclosure, the polyolefin may be various polyolefin resins known in this field. The specific examples may include polybutadiene, polyisoprene, styrene-butadiene copolymer, styrene-isoprene copolymer, styrene-butadiene-divinylbenzene terpolymer, styrene-butadiene copolymer adducted with maleic anhydride, vinyl-polybutadiene-urethane polymer, polybutadiene adducted with maleic anhydride, polymethylstyrene, hydrogenated polybutadiene, hydrogenated polyisoprene, hydrogenated styrene-butadiene-divinylbenzene terpolymer, hydrogenated styrene-butadiene copolymer adducted with maleic anhydride, hydrogenated styrene-butadiene copolymer, hydrogenated styrene-isoprene copolymer, multifunctional vinyl group-containing aromatic copolymer or a combination thereof, but the present disclosure is not limited thereto.

The multifunctional vinyl group-containing aromatic copolymer used in the present disclosure may include various multifunctional vinyl group-containing aromatic copolymers disclosed in the US Patent Application Publication No. 20070129502A1, all of which are incorporated herein by reference in their entirety.

For instance, in one exemplary embodiment of the present disclosure, the organic silicone resin may be various organic silicone resins known in this field. The specific examples may include polyalkylsiloxane, polyarylsiloxane, polyalkarylsiloxane, modified polysiloxane or a combination thereof, but the present disclosure is not limited thereto. Preferably, the organic silicone resin suitable for the present disclosure is an amino-modified organic silicone resin, such as the amino-modified organic silicone resin products KF-8010, X-22-161A, X-22-161B, KF-8012, KF-8008, X-22-9409 and X-22-1660B-3 available from Shin-Etsu Chemical Co., Ltd., the amino-modified organic silicone resin products BY-16-853U, BY-16-853 and BY-16-853B available from Toray-Dow corning Co., Ltd., the amino-modified organic silicone resin products XF42-C5742, XF42-C6252 and XF42-C5379 available from Momentive Performance Materials JAPAN LCC, or a combination thereof, but the present disclosure is not limited thereto.

For instance, in one exemplary embodiment of the present disclosure, the benzoxazine resin may be various benzoxazine resins known in this field. The specific examples may include bisphenol A benzoxazine resin, bisphenol F benzoxazine resin, phenolphthalein benzoxazine resin, dicyclopentadiene benzoxazine resin, phosphorus-containing benzoxazine resin, diamine benzoxazine resin and phenyl group-modified, vinyl group-modified or allyl group-modified benzoxazine resin, but the present disclosure is not limited thereto. The suitable commercial products may include such as products LZ-8270 (phenolphthalein benzoxazine resin), LZ-8298 (phenolphthalein benzoxazine resin), LZ-8280 (bisphenol F benzoxazine resin) and LZ-8290 (bisphenol A benzoxazine resin) available from Huntsman, or products KZH-5031 (vinyl group-modified benzoxazine resin) and KZH-5032 (phenyl group-modified benzoxazine resin) available from Kolon Industries. Among them, the diamine benzoxazine resin may be diaminodiphenylmethane benzoxazine resin, diaminodiphenyl ether benzoxazine resin, diaminodiphenyl sulfone benzoxazine resin, diaminodiphenyl sulfide benzoxazine resin or a combination thereof, but not limited thereto.

For instance, in one exemplary embodiment of the present disclosure, the epoxy resin may be various epoxy resins known in this field. From the perspective of improving thermal resistance of the resin composition, the epoxy resin may include such as bisphenol A epoxy resin, bisphenol F epoxy resin, bisphenol S epoxy resin, bisphenol AD epoxy resin, novolac epoxy resin, trifunctional epoxy resin, tetrafunctional epoxy resin, multifunctional novolac epoxy resin, dicyclopentadiene (DCPD) epoxy resin, phosphorus-containing epoxy resin, p-xylene epoxy resin, naphthalene epoxy resin (such as naphthol epoxy resin), benzofuran epoxy resin, isocyanate-modified epoxy resin or a combination thereof, but the present disclosure is not limited thereto. Among them, the novolac epoxy resin may be phenol novolac epoxy resin, bisphenol A novolac epoxy resin, bisphenol F novolac epoxy resin, biphenyl novolac epoxy resin, phenol benzaldehyde epoxy resin, phenol aralkyl novolac epoxy resin or o-cresol novolac epoxy resin. Among them, the phosphorus-containing epoxy resin may be DOPO (9,10-dihydro-9-oxa-10-phosphaphenanthrene-10-oxide) epoxy resin, DOPO-HQ epoxy resin or a combination thereof. The DOPO epoxy resin may be one or more selected from DOPO-containing phenol novolac epoxy resin, DOPO-containing o-cresol novolac epoxy resin and DOPO-containing bisphenol A novolac epoxy resin, but not limited thereto. The DOPO-HQ epoxy resin may be one or more selected from DOPO-HQ-containing phenol novolac epoxy resin, DOPO-HQ-containing o-cresol novolac epoxy resin and DOPO-HQ-containing bisphenol A novolac epoxy resin, but not limited thereto.

For instance, in one exemplary embodiment of the present disclosure, the polyester resin may be various polyester resins known in this field. The specific examples may include dicyclopentadiene-containing polyester resin and naphthalene-containing polyester resin, but the present disclosure is not limited thereto. The specific examples may include products HPC-8000 or HPC-8150 available from D.I.C. Corporation, but the present disclosure is not limited thereto.

For instance, in one exemplary embodiment of the present disclosure, the phenol resin may be various phenol resins known in this field. The specific examples may include novolac resin or phenoxy resin, but the present disclosure is not limited thereto. Among them, the novolac resin may include phenol novolac resin, o-cresol novolac resin, bisphenol A novolac resin, naphthol novolac resin, biphenyl novolac resin and dicyclopentadiene phenol resin, but not limited thereto.

For instance, in one exemplary embodiment of the present disclosure, the amine curing agent may be various amine curing agents known in this field. The specific examples may include at least one of diaminodiphenyl sulfone, diaminodiphenyl methane, diaminodiphenyl ether, diaminodiphenyl sulfide and dicyandiamide, or a combination thereof, but the present disclosure is not limited thereto.

For instance, in one exemplary embodiment of the present disclosure, the polyamide may be various polyamides known in this field and may include various commercial polyamide resin products, but the present disclosure is not limited thereto.

For instance, in one exemplary embodiment of the present disclosure, the polyimide may be various polyimides known in this field and may include various commercial polyimide resin products, but the present disclosure is not limited thereto.

For instance, in one exemplary embodiment of the present disclosure, the styrene maleic anhydride may be various styrene maleic anhydrides known in this field, wherein the ratio of styrene (S) to maleic anhydride (MA) may be 1/1, 2/1, 3/1, 4/1, 6/1, 8/1 or 12/1. The specific examples may include the styrene maleic anhydride copolymer products SMA-1000, SMA-2000, SMA-3000, EF-30, EF-40, EF-60 and EF-80 available from Cray Valley, or the styrene maleic anhydride copolymer products C400, C500, C700 and C900 available from Polyscope, but not limited thereto.

For instance, in one exemplary embodiment of the present disclosure, the maleimide resin other than the polymer represented by Formula (1) may be various maleimide resins other than the polymer represented by Formula (1) known in this field. The specific examples may include 4,4′-diphenylmethane bismaleimide, polyphenylmethane maleimide (also referred as oligomer of phenylmethane maleimide), bisphenol A diphenyl ether bismaleimide, 3,3′-dimethyl-5,5′-diethyl-4,4′-diphenylmethane bismaleimide, 3,3′-dimethyl-5,5′-dipropyl-4,4′-diphenylmethane bismaleimide, m-phenylene bismaleimide, 4-methyl-1,3-phenylene bismaleimide, 1,6-bismaleimide-(2,2,4-trimethyl)hexane, N-2,3-xylylmaleimide, N-2,6-xylylmaleimide, N-phenylmaleimide, vinyl benzyl maleimide (VBM), meta-arylene-containing maleimide, biphenyl alkylene-containing maleimide, indane-containing maleimide, maleimide resin containing an aliphatic structure with 10 to 50 carbon atoms, prepolymer of diallyl compound and maleimide resin, prepolymer of diamine and maleimide resin, prepolymer of multifunctional amine and maleimide resin, prepolymer of acid phenol compound and maleimide resin or a combination thereof, but the present disclosure is not limited thereto. These components should include their modifications. Among them, the meta-arylene-containing maleimide may be the maleimide resin product MIR-5000 available from Nippon Kayaku Co., Ltd.

For instance, in one exemplary embodiment of the present disclosure, the maleimide resin other than the polymer represented by Formula (1) may be such as the maleimide resin products BMI-1000, BMI-1000H, BMI-1100, BMI-1100H, BMI-2000, BMI-2300, BMI-3000, BMI-3000H, BMI-4000, BMI-5000, BMI-5100, BMI-TMH, BMI-7000 and BMI-7000H available from Daiwakasei Industry Co., Ltd, the maleimide resin products BMI-70 and BMI-80 available from K.I Chemical Industry Co., Ltd., or the maleimide resin products MIR-3000 and MIR-5000 available from Nippon Kayaku Co., Ltd., but the present disclosure is not limited thereto

For instance, in one exemplary embodiment of the present disclosure, the maleimide resin containing an aliphatic structure with 10 to 50 carbon atoms, also known as imide-extended maleimide resin, may include various imide-extended maleimide resins disclosed in the TW Patent Application Publication No. 200508284A, all of which are incorporated herein by reference in their entirety. The maleimide resin containing an aliphatic structure with 10 to 50 carbon atoms suitable for the present disclosure may include such as the maleimide resin products BMI-689, BMI-1400, BMI-1500, BMI-1700, BMI-2500, BMI-3000, BMI-5000 and BMI-6000 available from Designer Molecules Inc., but the present disclosure is not limited thereto

For instance, in one exemplary embodiment of the present disclosure, the cyanate ester resin may be various cyanate ester resins known in this field, such as a compound with a structure of Ar—O—C≡N, wherein Ar may be substituted or unsubstituted aryl group. From the perspective of improving thermal resistance of the resin composition, the specific examples of the cyanate ester resin may include novolac cyanate ester resin, bisphenol A cyanate ester resin, bisphenol F cyanate ester resin, dicyclopentadiene-containing cyanate ester resin, naphthalene-containing cyanate ester resin, phenolphthalein cyanate ester resin, adamantane cyanate ester resin, fluorene cyanate ester resin or a combination thereof, but the present disclosure is not limited thereto. Among them, the novolac cyanate ester resin may be bisphenol A novolac cyanate ester resin, bisphenol F novolac cyanate ester resin or a combination thereof. For instance, the cyanate ester resin may be the cyanate ester resin products Primaset PT-15, PT-30S, PT-60S, BA-200, BA-230S, BA-3000S, BTP-2500, BTP-6020S, DT-4000, DT-7000, ULL950S, HTL-300, CE-320, LVT-50 and LeCy available from Lonza.

For instance, in one exemplary embodiment of the present disclosure, the maleimide triazine resin used in the present disclosure is not particularly limited and may be any one or more of the maleimide triazine resins suitable for manufacturing a prepreg, a resin film, a laminate or a printed circuit board. For instance, the maleimide triazine resin may be derived by polymerizing the cyanate ester resin and the maleimide resin. For instance, the maleimide triazine resin may be derived by polymerizing the bisphenol A cyanate ester resin and the maleimide resin, by polymerizing the bisphenol F cyanate ester resin and the maleimide resin, by polymerizing the phenol novolac cyanate ester resin and the maleimide resin, or by polymerizing dicyclopentadiene-containing cyanate ester resin and the maleimide resin, but not limited thereto. For instance, the maleimide triazine resin may be derived by polymerizing the cyanate ester resin and the maleimide resin at any molar ratio. For instance, with respect to 1 mole of the maleimide resin, the cyanate ester resin may be 1 to 10 moles. For instance, with respect to 1 mole of the maleimide resin, the cyanate ester resin is 1, 2, 4 or 6 moles, but not limited thereto.

For instance, in one exemplary embodiment of the present disclosure, a curing accelerator, a polymerization inhibitor, a flame retardant, an inorganic filler, a surfactant, a coloring agent, a toughening agent, a solvent or a combination thereof may be further added to the resin composition of the present disclosure as needed.

For instance, in one exemplary embodiment of the present disclosure, the curing accelerator (including curing initiator) may include a catalyst, such as a Lewis base or a Lewis acid. The Lewis base may include one or more of imidazole, boron trifluoride-amine complex, ethyltriphenyl phosphonium chloride, 2-methylimidazole (2MI), 2-phenyl-1H-imidazole (2PZ), 2-ethyl-4-methylimidazole (2E4MI), triphenylphosphine (TPP) and 4-dimethylaminopyridine (DMAP). The Lewis acid may include metal salt compounds, such as metal salt compounds of manganese, iron, cobalt, nickel, copper and zinc, or metal catalysts, such as zinc octanoate or cobalt octanoate. The curing accelerator also includes a curing initiator, such as a peroxide capable of producing free radicals. The curing initiator includes dicumyl peroxide, tert-butyl peroxybenzoate, dibenzoyl peroxide (BPO), 2,5-dimethyl-2,5-di(tert-butylperoxy)-3-hexyne (25B), bis(tert-butylperoxyisopropyl)benzene or a combination thereof, but the present disclosure is not limited thereto. For instance, in one exemplary embodiment, with respect to 100 parts by weight of the unsaturated carbon-carbon double bond-containing polyphenylene ether resin, the resin composition of the present disclosure may further include 0.01 parts by weight to 5.0 parts by weight of the curing accelerator, preferably 0.01 parts by weight to 4.0 parts by weight of the curing accelerator, more preferably 0.1 parts by weight to 2.0 parts by weight of the curing accelerator, but not limited thereto.

For instance, in one exemplary embodiment of the present disclosure, the polymerization inhibitor may include 1,1-diphenyl-2-picrylhydrazyl, methyl acrylonitrile, 2,2,6,6-tetramethylpiperidine-1-oxyl, dithioester, nitroxide-mediated radical, triphenylmethyl radical, metal ion radical, sulfur radical, hydroquinone, 4-methoxyphenol, p-benzoquinone, phenothiazine, 0-phenylnaphthylamine, 4-t-butylcatechol, methylene blue, 4,4′-butylidene bis (6-t-butyl-3-methylphenol), 2,2′-methylene bis(4-ethyl-6-t-butylphenol) or a combination thereof, but the present disclosure is not limited thereto. For instance, the nitroxide-mediated radical may include nitroxide radicals derived from cyclic hydroxylamines, such as 2,2,6,6-substituted piperidine 1-oxyl free radical or 2,2,5,5-substituted pyrrolidine 1-oxyl free radical, but the present disclosure is not limited thereto. As substitutes, alkyl groups with 4 or less carbon atoms, such as methyl group or ethyl group, are preferred. The specific nitroxide radicals-containing compound is not particularly limited, and the examples thereof may include 2,2,6,6-tetramethylpiperidine 1-oxyl free radical, 2,2,6,6-tetraethylpiperidine 1-oxyl free radical, 2,2,6,6-tetramethyl-4-oxo-piperidine 1-oxyl free radical, 2,2,5,5-tetramethylpyrrolidine 1-oxyl free radical, 1,1,3,3-tetramethyl-2-isoindoline oxygen radical, N,N-di-tert-butylamine oxygen free radical and the like, but the present disclosure is not limited thereto. The nitroxide radicals may also be replaced by stable radicals such as galvinoxyl radicals. The polymerization inhibitor suitable for the resin composition of the present disclosure may also be products derived from the polymerization inhibitor with its hydrogen atom or atomic group substituted by other atom or atomic group, for instance, products derived from a polymerization inhibitor with its hydrogen atom substituted by an amino group, a hydroxyl group, a carbonyl group or the like. For instance, in one exemplary embodiment, with respect to 100 parts by weight of the unsaturated carbon-carbon double bond-containing polyphenylene ether resin, the resin composition of the present disclosure may further include 0.001 parts by weight to 20 parts by weight of the polymerization inhibitor, preferably 0.01 parts by weight to 10 parts by weight of the polymerization inhibitor, but not limited thereto.

For instance, in one exemplary embodiment of the present disclosure, the flame retardant may be any one or more of the flame retardants suitable for manufacturing a prepreg, a resin film, a laminate or a printed circuit board, such as phosphorus-containing flame retardant or bromine-containing flame retardant, but the present disclosure is not limited thereto. The bromine-containing flame retardant preferably includes decabromodiphenyl ethane. The phosphorus-containing flame retardant preferably includes hydroquinone bis-(diphenyl phosphate), bisphenol A bis-(diphenylphosphate), tri(2-carboxyethyl) phosphine (TCEP), tris(chloroisopropyl) phosphate, trimethyl phosphate (TMP), dimethyl methyl phosphonate (DMMP), resorcinol bis(dixylenyl phosphate) (RDXP) (such as commercially available products PX-200, PX-201, PX-202 and the like), ammonium polyphosphate, melamine polyphosphate, DPPO (diphenylphosphine oxide) and its derivatives (such as di-DPPO compound) or resins, melamine cyanurate, tri-hydroxy ethyl isocyanurate, aluminium phosphinate (such as products OP-930, OP-935 and the like) or a combination thereof.

For instance, in one exemplary embodiment of the present disclosure, the flame retardant may be the flame retardant available from Katayama Chemical Industries Co., Ltd., such as products V1, V2, V3, V4, V5, V7, S-2, S-4, E-4c, E-7c, E-8g, E-9g, E-10g, E-100, B-3, W-1o, W-2h, W-2o, W-3o, W-4o, OX-1, OX-2, OX-4, OX-6, OX-6+, OX-7, OX-7+, OX-13, BPE-1, BPE-3, HyP-2, API-9, CMPO, ME-20, C-1R, C-1S, C-3R, C-3S or C-11R, but the present disclosure is not limited thereto. The flame retardant used in the present disclosure may include one or more of the above flame retardants.

For instance, in one exemplary embodiment, with respect to 100 parts by weight of the unsaturated carbon-carbon double bond-containing polyphenylene ether resin, the resin composition of the present disclosure may further include 1 part by weight to 100 parts by weight of the flame retardant, preferably 5 parts by weight to 80 parts by weight of the flame retardant, but not limited thereto.

For instance, in one exemplary embodiment of the present disclosure, the inorganic filler may be any one or more of the inorganic fillers suitable for manufacturing a prepreg, a resin film, a laminate or a printed circuit board, and the specific examples may include silica (fused, non-fused, porous or hollow type), aluminum oxide, aluminum hydroxide, magnesium oxide, magnesium hydroxide, calcium carbonate, aluminum nitride, boron nitride, aluminum silicon carbide, silicon carbide, titanium dioxide, barium titanate, lead titanate, strontium titanate, calcium titanate, magnesium titanate, barium zirconate, lead zirconate, magnesium zirconate, lead zirconate titanate, zinc molybdate, calcium molybdate, magnesium molybdate, ammonium molybdate, zinc molybdate-modified talc, zinc oxide, zirconium oxide, mica, boehmite (AlOOH), calcined talc, talc, silicon nitride, zirconium tungstate, petalite, calcined kaolin or a combination thereof, but the present disclosure is not limited thereto. In addition, the inorganic filler may be spherical, fibrous, plate-like, particulate, flake-like or whisker-like and may be optionally pretreated by a silane coupling agent. In addition, the inorganic filler may be prepared in various ways, such as a deflagration method and a chemical synthesis method, but the present disclosure is not limited thereto. For instance, in one exemplary embodiment, with respect to 100 parts by weight of the unsaturated carbon-carbon double bond-containing polyphenylene ether resin, the resin composition of the present disclosure may further include 10 parts by weight to 300 parts by weight of the inorganic filler, preferably 60 parts by weight to 250 parts by weight of the inorganic filler, more preferably 100 parts by weight to 240 parts by weight of the inorganic filler, but not limited thereto.

For instance, in one exemplary embodiment of the present disclosure, the type of the surfactant is not particularly limited. For instance, the surfactant may include silane, such as siloxane, and may be further categorized according to the functional groups into amino silane, epoxide silane, vinyl silane, hydroxyl silane, isocyanate silane, methacryloxy silane and acryloxy silane, but the present disclosure is not limited thereto. The purpose of adding the surfactant in the present disclosure is to evenly disperse the inorganic filler in the resin composition.

For instance, in one exemplary embodiment of the present disclosure, the coloring agent may include dye or pigment, but the present disclosure is not limited thereto.

For instance, in one exemplary embodiment of the present disclosure, the toughening agent may include carboxyl-terminated butadiene acrylonitrile rubber (CTBN), core-shell rubber, ethylene propylene rubber or a combination thereof, but the present disclosure is not limited thereto. For instance, in one exemplary embodiment, with respect to 100 parts by weight of the unsaturated carbon-carbon double bond-containing polyphenylene ether resin, the resin composition of the present disclosure may further include 1 part by weight to 20 parts by weight of the toughening agent, preferably 3 parts by weight to 10 parts by weight of the toughening agent, but not limited thereto. The purpose of adding toughening agent in the present disclosure is to improve the toughness of the resin composition.

For instance, the solvent suitable for the resin composition of the present disclosure is not particularly limited and may be any one solvent suitable for dissolving the resin composition of the present disclosure, and may include methanol, ethanol, ethylene glycol monomethyl ether, acetone, butanone (i.e. methyl ethyl ketone), methyl isobutyl ketone, cyclohexanone, toluene, xylene, methoxyethyl acetate, ethoxyethyl acetate, propoxyethyl acetate, ethyl acetate, dimethylformamide, dimethylacetamide, propylene glycol methyl ether acetate or a mixture solvent thereof, but the present disclosure is not limited thereto. The amount of the solvent is adjusted depending on the desired overall solid content of the resin composition. For instance, in one exemplary embodiment, the amount of the solvent is adjusted to allow the overall solid content of the resin composition to be 50-85%, but not limited thereto.

The above polymer or the above resin composition may be made into various products, such as components applicable to various electronic products, including a prepreg, a resin film, a laminate or a printed circuit board, but the present disclosure is not limited thereto.

For instance, in one exemplary embodiment of the present disclosure, the polymer or the resin composition from each exemplary embodiments of the present disclosure may be made into a prepreg, which includes a reinforcement material and a layered structure disposed thereon. The layered structure is formed by heating the polymer or the resin composition at a high temperature to the semi-cured state (B-stage). The baking temperature for making the prepreg is between 120° C. and 180° C., preferably between 120° C. and 160° C. The reinforcement material may be any one of fiber material, woven fabric and non-woven fabric, and the woven fabric preferably includes fiberglass fabrics. The types of the fiberglass fabrics are not particularly limited and may be various fiberglass fabric used for printed circuit boards, such as E-glass fabric, D-glass fabric, S-glass fabric, T-glass fabric, L-glass fabric, Q-glass fabric or QL-glass fabric (a glass fabric with a mixed structure made of Q-glass fabric and L-glass fabric); and the type of the fiberglass may include yarns and rovings, in spread form or standard form, with a section of a circle or flat shape. The non-woven fabric preferably includes liquid crystal resin non-woven fabric, such as polyester non-woven fabric, polyurethane non-woven fabric and so on, but not limited thereto. The woven fabric may also include liquid crystal resin woven fabric, such as polyester woven fabric, polyurethane woven fabric and so on, but not limited thereto. The reinforcement material may increase the mechanical strength of the prepreg. In one preferred exemplary embodiment, the reinforcement material may be optionally pre-treated by a silane coupling agent. The prepreg may be further heated and cured to C-stage to form an insulation layer.

For instance, in one exemplary embodiment of the present disclosure, the polymer or the resin composition from each exemplary embodiments of the present disclosure may be made into a resin film, which is prepared by heating and baking to semi-cure the polymer or the resin composition. The polymer or the resin composition may be selectively coated on a liquid crystal resin film, a polytetrafluoroethylene film, a polyethylene terephthalate film (PET film), a polyimide film (PI film), a copper foil or a resin-coated copper, followed by heating and baking to a semi-cured state so as to make the polymer or the resin composition form into the resin film.

For instance, in one exemplary embodiment of the present disclosure, the polymer or the resin composition of the present disclosure may be made into various laminates, which include at least two metal foils and at least one insulation layer disposed between the two metal foils, wherein the insulation layer may be made by curing the polymer or the resin composition at high temperature and high pressure to C-stage, a suitable curing temperature may be such as between 190° C. and 220° C., preferably between 200° C. and 210° C., and a curing time may be 90 to 180 minutes, preferably 120 to 150 minutes. The insulation layer may be formed by curing the prepreg or the resin film. The material of the metal foil may be copper, aluminum, nickel, platinum, silver, gold or alloy thereof, such as a copper foil. In one preferred exemplary embodiment, the laminate is a copper-clad laminate.

For instance, in one exemplary embodiment of the present disclosure, the laminate may be further processed by circuit formation processes to be made into a printed circuit board.

One of the manufacturing methods of the printed circuit board of the present disclosure may be as follows. A double-sided copper-clad laminate (such as product EM-827, available from Elite Material Co., Ltd.) with a thickness of 28 mil and having a 1 ounce (oz) HTE (high temperature elongation) copper foil may be used and subject to drilling and then electroplating, so as to form electrical conduction between the upper layer copper foil and the bottom layer copper foil. Then, the upper layer copper foil and the bottom layer copper foil are etched to form inner layer circuit board. Then, brown oxidation and roughening are performed on the inner layer circuit board to form uneven structure on the surface to increase roughness. Next, a copper foil, the prepreg, the inner layer circuit board, the prepreg and a copper foil are stacked in sequence, and a vacuum lamination apparatus is used to heat them at 190° C. to 220° C. for 90 to 180 minutes to cure the material of the insulation layer of the prepregs. Next, black oxidation, drilling, copper plating and other known circuit board processes are performed on the outmost surface copper foil so as to obtain the printed circuit board.

For instance, in one exemplary embodiment of the present disclosure, the above polymer, resin composition and article made therefrom preferably have at least one of the following properties:
a glass transition temperature as measured by reference to IPC-TM-650 2.4.24.4 of greater than or equal to 269° C., such as between 269° C. and 360° C., such as between 280° C. and 360° C.;
a T300 thermal resistance as measured by reference to IPC-TM-650 2.4.24.1 of greater than 70 minutes, such as greater than 90 minutes, greater than 100 minutes or greater than 130 minutes, such as between 71 minutes and 130 minutes, such as between 71 minutes and 80 minutes;
a percent thermal expansion at Z-axis as measured by reference to IPC-TM-650 2.4.24.5 of less than or equal to 1.2%, such as between 0.6% and 1.2%;
a dissipation factor at 10 GHz as measured by reference to JISC2565 of less than or equal to 0.0018, such as between 0.0014 and 0.0018;
a dissipation factor variation rate under moisture and heat of less than or equal to 8%, such as between 0% and 8%, calculated by a dissipation factor of the article placed at room temperature and a dissipation factor of the article placed at a temperature of 85° C. and a relative humidity of 85% for 120 hours respectively at 10 GHz as measured by reference to JISC2565;
a dissipation factor variation rate under heat of less than or equal to 8%, such as between 0% and 8%, calculated by a dissipation factor of the article placed at room temperature and a dissipation factor of the article placed at a temperature of 125° C. for 120 hours respectively at 10 GHz as measured by reference to JISC2565;
a water absorption rate as measured by reference to IPC-TM-650 2.6.2.1 and IPC-TM-650 2.6.16.1 of less than or equal to 0.25%, such as between 0.20% and 0.25%.

For instance, in one exemplary embodiment of the present disclosure, the above polymer, resin composition and article made therefrom preferably have the following property:
no delamination after a pressure cooking test by reference to IPC-TM-650 2.6.16.1 and IPC-TM-650 2.4.23.

In the present disclosure, the test samples (samples) of the examples and comparative examples are prepared according to the following methods, and the property tests thereof are performed based on the specific test conditions.

### 1. Prepreg

The composition from each Examples and each Comparative Examples is separately well-mixed to form a varnish, which is then loaded to an impregnation tank, and a fiberglass fabric (e.g., 2116 L-glass fiber fabric, 1080 L-glass fiber fabric or 1078 L-glass fiber fabric, all available from Asahi) is immersed into the impregnation tank to adhere the composition onto the fiberglass fabric, followed by heating at 150° C. to 170° C. to a semi-cured state (B stage), thereby obtaining a prepreg.

### 2. Copper-Clad Laminate (8-Ply, Formed by Laminating Eight Prepregs)

Two 18 m HVLP copper foils and eight prepregs obtained from 2116 L-glass fiber fabrics impregnated with each Examples and Comparative Examples and each having a resin content of about 53% are prepared and stacked in the order of one HVLP copper foil, eight prepregs and one HVLP copper foil, followed by lamination under vacuum at 500 psi and 200° C. for 2 hours to form a copper-clad laminate. The eight prepregs stacked with each other are cured and formed into an insulation layer between the two copper foils, and a resin content of the insulation layer is about 53%.

### 3. Copper-Free Laminate (8-Ply, Formed by Laminating Eight Prepregs)

The above copper-clad laminate (8-ply) is etched to remove the two copper foils, thereby obtaining a copper-free laminate (8-ply). The copper-free laminate is formed by laminating eight prepregs, and the copper-free laminate has a resin content of about 53%.

### 4. Copper-Free Laminate (2-Ply, Formed by Laminating Two Prepregs)

Two 18 m HVLP copper foils and two prepregs obtained from 1080 L-glass fiber fabrics impregnated with each Examples and Comparative Examples are prepared and stacked in the order of one copper foil, two prepregs and one copper foil, followed by lamination under vacuum at 500 psi and 200° C. for 2 hours to form a copper-clad laminate (2-ply, formed by laminating two prepregs). Then, the copper-clad laminate (2-ply) is etched to remove the two copper foils, thereby obtaining a copper-free laminate (2-ply). The copper-free laminate is formed by two prepregs, and the copper-free laminate (2-ply) has a resin content of about 70%.

The test method and the property analysis are described below.

### 1. Glass Transition Temperature (Tg)

The copper-free laminate (8-ply) is used as a sample, and the glass transition temperature (° C.) of each sample is measured by reference to IPC-TM-650 2.4.24.4 using a dynamic mechanical analyzer (DMA) with a temperature range of 50° C. to 400° C. and a temperature increasing rate of 2° C./minute.

### 2. T300 Thermal Resistance

In the measurement of T300 thermal resistance, the copper-clad laminate (8-ply, formed by laminating eight prepregs) is used as a sample. Each sample is measured at a constant temperature of 300° C. by reference to IPC-TM-650 2.4.24.1 using a thermal mechanical analyzer (TMA) to measure the time for delamination of the copper-clad laminate due to heat. The longer time for delamination represents better thermal resistance of the copper-clad laminate made from the resin composition. When the test time exceeds 70 minutes and there is no delamination, it is marked as “>70”.

### 3. Percent Thermal Expansion at Z-Axis (Z-PTE)

The copper-free laminate (8-ply) is used as a sample and subjected to a thermal mechanical analysis (TMA). The sample is heated at a temperature increasing rate of 10° C./minute from 50° C. to 260° C., and the percent thermal expansion at Z-axis (%) in a temperature range of 50° C. to 260° C. of each sample is measured by reference to IPC-TM-650 2.4.24.5.

### 4. Dissipation Factor (Df)

The copper-free laminate (2-ply) is used as a sample, and each sample is measured at 10 GHz at room temperature (25° C.) by reference to JISC2565 using a microwave dielectrometer (available from AET Corp.). The lower dissipation factor represents better dielectric property of the sample. At a measurement frequency of 10 GHz, for Df value less than 0.002, a difference in Df values of greater than or equal to 0.0001 represents a significant difference in dissipation factors of different laminates (i.e., significant technical difficulty is present).

### 5. Dissipation Factor Variation Rate Under Moisture and Heat (Df Variation Rate Under Moisture and Heat)

The copper-free laminate (2-ply) is used as a sample, and the dissipation factor at 10 GHz at room temperature (25° C.) of each sample is measured by reference to JISC2565 using a microwave dielectrometer (available from AET Corp.) and designated as Df1. Then, the sample is washed with distilled water and placed in an environment of 85° C. and 85% relative humidity for 120 hours, followed by another measurement of the dissipation factor at 10 GHz, which is designated as Df2. The Df variation rate under moisture and heat=[(Df2-Df1)/Df1]*100%. The lower dissipation factor variation rate under moisture and heat represents better dielectric stability.

### 6. Dissipation Factor Variation Rate Under Heat (Df Variation Rate Under Heat)

The copper-free laminate (2-ply) is used as a sample, and the dissipation factor at 10 GHz at room temperature (25° C.) of each sample is measured by reference to JISC2565 using a microwave dielectrometer (available from AET Corp.) and designated as Df3. Then, the sample is washed with distilled water and placed in an environment of 125° C. for 120 hours, followed by another measurement of the dissipation factor at 10 GHz, which is designated as Df4. The Df variation rate under heat=[(Df4-Df3)/Df3]*100%. The lower dissipation factor variation rate under heat represents better dielectric stability.

### 7. Water Absorption Rate

The copper-free laminate (8-ply) with a size of 2 inches*2 inches is used as a sample, baked in an oven of 105±10° C. for 1 hour by reference to IPC-TM-650 2.6.2.1 and cooled at room temperature (about 25° C.) for 10 minutes, and then the sample is weighed as W₁. Then, the sample is subjected to a pressure cooking test (PCT) by reference to IPC-TM-650 2.6.16.1 for moisture absorption for 3 hours (the test temperature of 121° C. and the relative humidity of 100%), and then the copper-free laminate is cooled and wiped to remove residual water on the surface, and the sample is weighed to give a weight as W₂. The water absorption rate is calculated as follows:

Water absorption rate (%)=[(W₂−W₁)/W₁]*100%

### 8. Pressure Cooking Test (PCT)

The copper-free laminate (8-ply) is used as a sample and subjected to a pressure cooking test by reference to IPC-TM-650 2.6.16.1 for moisture absorption for 3 hours (the test temperature of 121° C. and the relative humidity of 100%), then immersed into a solder bath of 288° C. for 20 seconds by reference to IPC-TM-650 2.4.23, and then inspected for the presence of delamination (the presence of delamination means failure, the absence of delamination means pass, “O” represents there is no delamination, and “X” represents there is delamination), and each group has three samples. One “X” represents that delamination present in one sample among the three samples in PCT; two “X” represents that delamination present in two samples among the three samples in PCT; and three “X” represents that delamination present in three samples among the three samples in PCT. For instance, delamination refers to interlayer delamination between the insulation layers. The interlayer delamination refers to the phenomenon of blistering and separation between any layers of the laminate.

The resin compositions of Examples and Comparative Examples of the present disclosure are prepared by the following raw materials according to the amounts listed in Table 1 to Table 3 and further made into various test samples.

The chemical materials used in Examples and Comparative Examples of the present disclosure are described below.

Polymers P1 to P7: prepared by Applicant and described below.

Intermediate 1: prepared by Applicant and described below.

SA9000: (meth)acryloyl group-containing polyphenylene ether resin, available from Sabic.

OPE-2st 1200: vinylbenzyl group-containing polyphenylene ether resin, available from Mitsubishi Gas Chemical Co., Inc.

OPE-2st 2200: vinylbenzyl group-containing polyphenylene ether resin, available from Mitsubishi Gas Chemical Co., Inc.

Maleic anhydride: available from Aladdin Scientific Corp.

Monoadamantane: available from Sichuan Zhongbang New Material Co., Ltd.

BMI-5100: 3,3′-dimethyl-5,5′-diethyl-4,4′-diphenylmethane bismaleimide, available from Daiwakasei Industry.

BMI-2300: phenylmethane maleimide oligomer, available from Daiwakasei Industry.

Compound D1, having the following structure, prepared by Applicant:

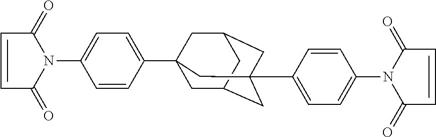 [SMILES: O=C1C=CC(=O)N1c1ccc(C23CC4CC(C2)CC(c2ccc(N5C(=O)C=CC5=O)cc2)(C4)C3)cc1]

Compound D2, having the following structure, a polymer with high molecule weight, prepared by Applicant:

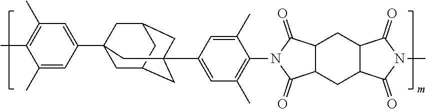

Compound D3, having the following structure, prepared by Applicant:

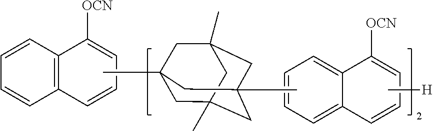

TAIC: triallyl isocyanurate, commercially available.

DVB: divinylbenzene, available from Shanghai Macklin Biochemical Technology Co., Ltd.

BVPE: bis(vinylphenyl)ethane, available from Linchuan Chemical Co., Ltd.

Synthetic spherical silicon: spherical silicon with a purity of; >99.8% prepared by chemical synthesis, commercially available or prepared by Applicant.

25B: 2,5-dimethyl-2,5-di(tert-butylperoxy)-3-hexyne, available from NOF Corporation.

Mixed solvent of toluene and butanone: a weight ratio of toluene to butanone is 1:1, toluene and butanone are commercially available. The amount is expressed as “proper amount” (abbreviated as “PA”) which represents the amounts of toluene and butanone are adjusted to allow the overall solid content of the resin composition to be 60% to 68% (solid content, S/C=60% to 68%).

### Preparation Example 1: Polymer P1

S1: 133 g (1.1 moles) of 2,6-dimethylaniline and 294 g (1 mole) of 1,3-dibromomonoadamantane are added to a reaction vessel, under a nitrogen atmosphere, heated to 100° C. and reacted for 3 hours, then raised to 190° C. and reacted for 18 hours, and then cooled to room temperature, and 15 wt % sodium hydroxide aqueous solution is added thereto, followed by purifying to obtain Intermediate 1 with the following structure formula and having a number average molecular weight of about 13000.

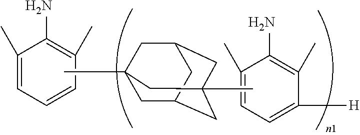

S2: 10.8 g (0.11 moles) of maleic anhydride and 200 mL of acetone are added to a reaction vessel, after maleic anhydride is dissolved, 25.5 g (0.002 moles) of Intermediate 1 dissolved in 200 mL of acetone is added thereto, they are reacted at room temperature for 4 hours, and then 2.6 g of triethylamine, 36.4 g of acetic anhydride and 0.26 g of magnesium acetate are added thereto while raising to 63° C. and reacting for 6 hours, followed by purifying to obtain Polymer P1 with the following structure formula and having a number average molecular weight of about 17000.

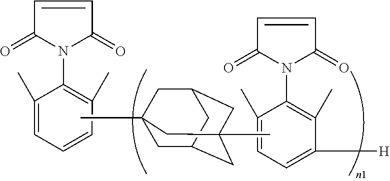

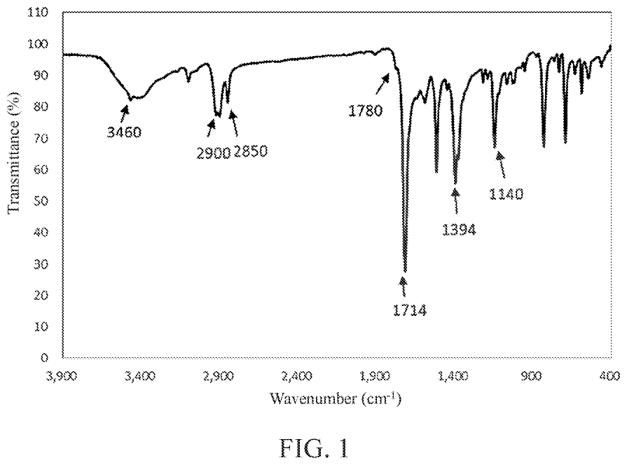

Polymer P1 prepared by Preparation Example 1 is analyzed with Fourier transform infrared spectroscopy (FTIR). The results are shown in FIG. 1, the peak at 3460 cm⁻¹ is the characteristic absorption peak of the imide ring, and the peaks at 1714 cm⁻¹ and 1780 cm⁻¹ are the vibration peaks of the carbonyl group on the imide ring. These indicate that Polymer P1 has a complete maleimide structure. In addition, there are also asymmetric and symmetric stretching vibration peaks of C—N-C near 1394 cm⁻¹ and 1140 cm⁻¹, and there are characteristic absorption peaks of adamantane, i.e. absorption peaks of saturated hydrocarbon, at 2900 cm⁻¹ and 2850 cm⁻¹. These results indicate that Polymer P1 is successfully synthesized.

### Preparation Example 2: Polymer P2

S1: 133 g (1.1 moles) of 2,6-dimethylaniline and 147 g (0.5 moles) of 1,3-dibromomonoadamantane are added to a reaction vessel, under a nitrogen atmosphere, heated to 100° C. and reacted for 2.5 hours, then raised to 190° C. and reacted for 12 hours, and then cooled to room temperature, and 15 wt % sodium hydroxide aqueous solution is added thereto, followed by purifying to obtain Intermediate 2 with the same structure formula as Intermediate 1 and having a number average molecular weight of about 5200.

S2: 10.8 g (0.11 moles) of maleic anhydride and 200 mL of acetone are added to a reaction vessel, after maleic anhydride is dissolved, 25.9 g (0.005 moles) of Intermediate 2 dissolved in 200 mL of acetone is added thereto, they are reacted at room temperature for 4 hours, and then 2.6 g of triethylamine, 36.7 g of acetic anhydride and 0.26 g of magnesium acetate are added thereto while raising to 60° C. and reacting for 5 hours, followed by purifying to obtain Polymer P2 with the same structure formula as Polymer P1 and having a number average molecular weight of about 7000.

### Preparation Example 3: Polymer P3

S1: 133 g (1.1 moles) of 2,6-dimethylaniline and 294 g (1 mole) of 1,3-dibromomonoadamantane are added to a reaction vessel, under a nitrogen atmosphere, heated to 100° C. and reacted for 3 hours, then raised to 190° C. and reacted for 5 hours, and then cooled to room temperature, and 15 wt % sodium hydroxide aqueous solution is added thereto, followed by purifying to obtain Intermediate 3 with the same structure formula as Intermediate 1 and having a number average molecular weight of about 1100.

S2: 12.8 g (0.13 moles) of maleic anhydride and 200 mL of acetone are added to a reaction vessel, after maleic anhydride is dissolved, 28.3 g (0.025 moles) of Intermediate 3 dissolved in 200 mL of acetone is added thereto, they are reacted at room temperature for 3 hours, and then 2.9 g of triethylamine, 41.1 g of acetic anhydride and 0.29 g of magnesium acetate are added thereto while raising to 60° C. and reacting for 4 hours, followed by purifying to obtain Polymer P3 with the same structure formula as Polymer P1 and having a number average molecular weight of about 1500.

### Preparation Example 4: Polymer P4

S1: 133 g (1.1 moles) of 2,6-dimethylaniline and 294 g (1 mole) of 1,3-dibromomonoadamantane are added to a reaction vessel, under a nitrogen atmosphere, heated to 100° C. and reacted for 2 hours, then raised to 190° C. and reacted for 3 hours, and then cooled to room temperature, and 15 wt % sodium hydroxide aqueous solution is added thereto, followed by purifying to obtain Intermediate 4 with the same structure formula as Intermediate 1 and having a number average molecular weight of about 600.

S2: 15.7 g (0.16 moles) of maleic anhydride and 250 mL of acetone are added to a reaction vessel, after maleic anhydride is dissolved, 31.4 g (0.05 moles) of Intermediate 4 dissolved in 250 mL of acetone is added thereto, they are reacted at room temperature for 3 hours, and then 3.2 g of triethylamine, 47.1 g of acetic anhydride and 0.32 g of magnesium acetate are added thereto while raising to 60° C. and reacting for 4 hours, followed by purifying to obtain Polymer P4 with the same structure formula as Polymer P1 and having a number average molecular weight of about 800.

### Preparation Example 5: Polymer P5

S1: 133 g (1.1 moles) of 2,6-dimethylaniline and 346 g (1 mole) of dibromodiamantane are added to a reaction vessel, under a nitrogen atmosphere, heated to 110° C. and reacted for 3 hours, then raised to 200° C. and reacted for 24 hours, and then cooled to room temperature, and 15 wt % sodium hydroxide aqueous solution is added thereto, followed by purifying to obtain Intermediate 5 with the following structure formula and having a number average molecular weight of about 6200.

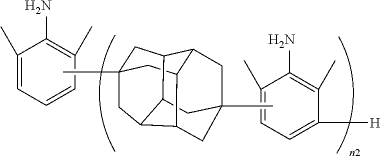

S2: 10.8 g (0.11 moles) of maleic anhydride and 250 mL of acetone are added to a reaction vessel, after maleic anhydride is dissolved, 31.2 g (0.005 moles) of Intermediate 5 dissolved in 250 mL of acetone is added thereto, they are reacted at room temperature for 4 hours, and then 3.1 g of triethylamine, 42 g of acetic anhydride and 0.31 g of magnesium acetate are added thereto while raising to 62° C. and reacting for 6 hours, followed by purifying to obtain Polymer P5 with the following structure formula and having a number average molecular weight of about 8000.

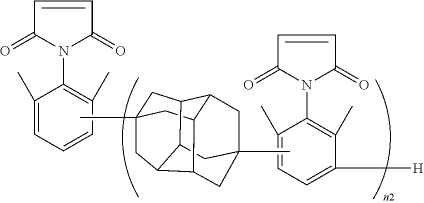

### Preparation Example 6: PolymerP6

S1: 133 g (1.1 moles) of 2,6-dimethylaniline and 346 g (1 mole) of dibromodiamantane are added to a reaction vessel, under a nitrogen atmosphere, heated to 100° C. and reacted for 3 hours, then raised to 200° C. and reacted for 4 hours, and then cooled to room temperature, and 15 wt % sodium hydroxide aqueous solution is added thereto, followed by purifying to obtain Intermediate 6 with the same structure formula as Intermediate 5 and having a number average molecular weight of about 700.

S2: 15.7 g (0.16 moles) of maleic anhydride and 300 mL of acetone are added to a reaction vessel, after maleic anhydride is dissolved, 36.6 g (0.05 moles) of Intermediate 6 dissolved in 300 mL of acetone is added thereto, they are reacted at room temperature for 2 hours, and then 3.7 g of triethylamine, 52.3 g of acetic anhydride and 0.37 g of magnesium acetate are added thereto while raising to 62° C. and reacting for 5 hours, followed by purifying to obtain Polymer P6 with the same structure formula as Polymer P5 and having a number average molecular weight of about 1000.

### Preparation Example 7: Polymer P7

S1: 13.3 g (0.11 moles) of 2,6-dimethylaniline and 39.8 g (0.1 moles) of dibromotriamantane are added to a reaction vessel, under a nitrogen atmosphere, heated to 100° C. and reacted for 3 hours, then raised to 200° C. and reacted for 6 hours, and then cooled to room temperature, and 15 wt % sodium hydroxide aqueous solution is added thereto, followed by purifying to obtain Intermediate 7 with the following structure formula and having a number average molecular weight of about 1500.

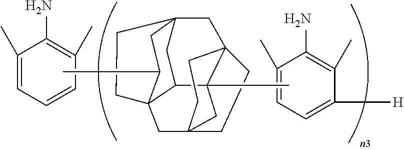

S2: 12.7 g (0.13 moles) of maleic anhydride and 300 mL of acetone are added to a reaction vessel, after maleic anhydride is dissolved, 38.7 g (0.025 moles) of Intermediate 7 dissolved in 300 mL of acetone is added thereto, they are reacted at room temperature for 2 hours, and then 3.9 g of triethylamine, 51.4 g of acetic anhydride and 0.39 g of magnesium acetate are added thereto while raising to 60° C. and reacting for 5 hours, followed by purifying to obtain Polymer P7 with the following structure formula and having a number average molecular weight of about 2000.

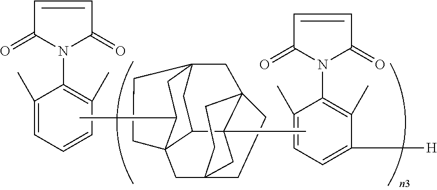

The components of the compositions (in parts by weight) and the property test results of the samples of Examples and Comparative Examples are shown in Table 1 to Table 3.

TABLE 1
The components of the compositions (in parts by weight) and the property test results of their articles of Examples E1-E8

| Components | | E1 | E2 | E3 | E4 | E5 | E6 | E7 | E8 |
|---|---|---|---|---|---|---|---|---|---|
| Unsaturated | SA9000 | | | | 100 | 100 | 100 | 100 | 100 |
| C═C double | OPE-2st 2200 | | | | | | | | |
| bond- | OPE-2st 1200 | | | | | | | | |
| containing | | | | | | | | | |
| polyphenylene | | | | | | | | | |
| ether | | | | | | | | | |
| Polymer | P1 | | | | 50 | | | | |
| represented by | P2 | | | | | 50 | | | |
| Formula (1) | P3 | 100 | | | | | 10 | 20 | 50 |
| | P4 | | | | | | | | |
| | P5 | | | | | | | | |
| | P6 | | 100 | | | | | | |
| | P7 | | | 100 | | | | | |
| Synthetic raw | Intermediate 1 | | | | | | | | |
| materials | Maleic anhydride | | | | | | | | |
| | Monoadamantane | | | | | | | | |
| Maleimide | BMI-5100 | | | | | | | | |
| resin other | BMI-2300 | | | | | | | | |
| than the | | | | | | | | | |
| polymer | | | | | | | | | |
| represented by | | | | | | | | | |
| Formula (1) | | | | | | | | | |
| D1 | | | | | | | | | |
| D2 | | | | | | | | | |
| D3 | | | | | | | | | |
| Unsaturated | TAIC | | | | | | | | |
| C═C double | DVB | | | | | | | | |
| bond- | BVPE | | | | | | | | |
| containing | | | | | | | | | |
| crosslinking | | | | | | | | | |
| agent | | | | | | | | | |
| Inorganic filler | Synthetic | 150 | 150 | 150 | 150 | 150 | 150 | 150 | 150 |
| | spherical silicon | | | | | | | | |
| Curing | 25B | 0.6 | 0.6 | 0.6 | 0.6 | 0.6 | 0.6 | 0.6 | 0.6 |
| accelerator | | | | | | | | | |
| Solvent | Toluene/Butanone | PA | PA | PA | PA | PA | PA | PA | PA |
| Properties | Unit | E1 | E2 | E3 | E4 | E5 | E6 | E7 | E8 |
| Tg | ° C. | >350 | >350 | >350 | 280 | 297 | 269 | 282 | 301 |
| T-300 | min | >70 | >70 | >70 | >70 | >70 | >70 | >70 | >70 |
| Z-PTE | % | 0.6 | 0.7 | 0.8 | 0.9 | 0.9 | 1.2 | 1.1 | 1.0 |
| Df | — | 0.0014 | 0.0016 | 0.0017 | 0.0016 | 0.0016 | 0.0018 | 0.0017 | 0.0017 |
| Df variation | % | 0 | 2 | 2 | 6 | 6 | 8 | 7 | 7 |
| rate under | | | | | | | | | |
| moisture | | | | | | | | | |
| and heat | | | | | | | | | |
| Df variation | % | 0 | 2 | 2 | 6 | 6 | 8 | 7 | 7 |
| rate under | | | | | | | | | |
| heat | | | | | | | | | |
| Water | % | 0.22 | 0.20 | 0.22 | 0.20 | 0.21 | 0.20 | 0.21 | 0.21 |
| absorption | | | | | | | | | |
| rate | | | | | | | | | |
| PCT | — | ◯◯◯ | ◯◯◯ | ◯◯◯ | ◯◯◯ | ◯◯◯ | ◯◯◯ | ◯◯◯ | ◯◯◯ |

TABLE 2
The components of the compositions (in parts by weight) and the property test results of their articles of Examples E9-E16

| Components | | E9 | E10 | E11 | E12 | E13 | E14 | E15 | E16 |
|---|---|---|---|---|---|---|---|---|---|
| Unsaturated | SA9000 | 100 | 100 | 100 | | | 100 | 50 | 40 |
| C═C double | OPE-2st 2200 | | | | 100 | | | 40 | 40 |
| bond- | OPE-2st 1200 | | | | | 100 | | 10 | 20 |
| containing | | | | | | | | | |
| polyphenylene | | | | | | | | | |
| ether | | | | | | | | | |
| Polymer | P1 | | | | | | | | |
| represented by | P2 | | | | | | | | |
| Formula (1) | P3 | 70 | 80 | | | | | | 40 |
| | P4 | | | 50 | | | | | |
| | P5 | | | | 50 | | | 15 | |
| | P6 | | | | | 50 | | 10 | 15 |
| | P7 | | | | | | 50 | 5 | 10 |
| Synthetic raw | Intermediate 1 | | | | | | | | |
| materials | Maleic anhydride | | | | | | | | |
| | Monoadamantane | | | | | | | | |
| Maleimide | BMI-5100 | | | | | | | | |
| resin other than | BMI-2300 | | | | | | | | |
| the polymer | | | | | | | | | |
| represented by | | | | | | | | | |
| Formula (1) | | | | | | | | | |
| D1 | | | | | | | | | |
| D2 | | | | | | | | | |
| D3 | | | | | | | | | |
| Unsaturated | TAIC | | | | | | | | 5 |
| C═C double | DVB | | | | | | | 10 | |
| bond- | BVPE | | | | | | | 10 | |
| containing | | | | | | | | | |
| crosslinking | | | | | | | | | |
| agent | | | | | | | | | |
| Inorganic filler | Synthetic spherical | 150 | 150 | 150 | 150 | 150 | 150 | 100 | 240 |
| | silicon | | | | | | | | |
| Curing | 25B | 0.6 | 0.6 | 0.6 | 0.6 | 0.6 | 0.6 | 0.1 | 2.0 |
| accelerator | | | | | | | | | |
| Solvent | Toluene/Butanone | PA | PA | PA | PA | PA | PA | PA | PA |
| Properties | Unit | E9 | E10 | E11 | E12 | E13 | E14 | E15 | E16 |
| Tg | ° C. | 305 | 304 | 317 | 303 | 320 | 302 | 285 | 291 |
| T-300 | min | >70 | >70 | >70 | >70 | >70 | >70 | >70 | >70 |
| Z-PTE | % | 1.0 | 0.9 | 1.0 | 0.9 | 1.0 | 1.0 | 1.0 | 0.8 |
| Df | — | 0.0017 | 0.0017 | 0.0017 | 0.0017 | 0.0017 | 0.0016 | 0.0016 | 0.0016 |
| Df variation | % | 6 | 6 | 6 | 5 | 6 | 6 | 6 | 7 |
| rate under | | | | | | | | | |
| moisture | | | | | | | | | |
| and heat | | | | | | | | | |
| Df variation | % | 6 | 6 | 6 | 5 | 6 | 6 | 6 | 7 |
| rate under | | | | | | | | | |
| heat | | | | | | | | | |
| Water | % | 0.22 | 0.25 | 0.22 | 0.20 | 0.21 | 0.22 | 0.21 | 0.24 |
| absorption | | | | | | | | | |
| rate | | | | | | | | | |
| PCT | — | ◯◯◯ | ◯XX | ◯◯◯ | ◯◯◯ | ◯◯◯ | ◯◯◯ | ◯◯◯ | ◯◯◯ |

TABLE 3
The components of the compositions (in parts by weight) and the property
test results of their articles of Comparative Examples C1-C7

| Components | | C1 | C2 | C3 | C4 | C5 | C6 | C7 |
|---|---|---|---|---|---|---|---|---|
| Unsaturated | SA9000 | 100 | 100 | 100 | 100 | 100 | 100 | 100 |
| C═C double | OPE-2st 2200 | | | | | | | |
| bond- | OPE-2st 1200 | | | | | | | |
| containing | | | | | | | | |
| polyphenylene | | | | | | | | |
| ether | | | | | | | | |
| Polymer | P1 | | | | | | | |
| represented by | P2 | | | | | | | |
| Formula (1) | P3 | | | | | | | |
| | P4 | | | | | | | |
| | P5 | | | | | | | |
| | P6 | | | | | | | |
| | P7 | | | | | | | |
| Synthetic raw | Intermediate 1 | 33.6 | | | | | | |
| materials | Maleic anhydride | 16.4 | | | | | | |
| | Monoadamantane | | 7.3 | | | | | |
| Maleimide resin | BMI-5100 | | | 50 | | | | |
| other than the | BMI-2300 | | 42.7 | | 50 | | | |
| polymer | | | | | | | | |
| represented by | | | | | | | | |
| Formula (1) | | | | | | | | |
| D1 | | | | | | 50 | | |
| D2 | | | | | | | 50 | |
| D3 | | | | | | | | 50 |
| Unsaturated | TAIC | | | | | | | |
| C═C double | DVB | | | | | | | |
| bond- | BVPE | | | | | | | |
| containing | | | | | | | | |
| crosslinking | | | | | | | | |
| agent | | | | | | | | |
| Inorganic | Synthetic | 150 | 150 | 150 | 150 | 150 | 150 | 150 |
| filler | spherical | | | | | | | |
| | silicon | | | | | | | |
| Curing | 25B | 0.6 | 0.6 | 0.6 | 0.6 | 0.6 | 0.6 | 0.6 |
| accelerator | | | | | | | | |
| Solvent | Toluene/Butanone | PA | PA | PA | PA | PA | PA | PA |
| Properties | Unit | C1 | C2 | C3 | C4 | C5 | C6 | C7 |
| Tg | ° C. | 204 | 245 | 246 | 252 | 255 | Unable | 264 |
| T-300 | min | <5 | <5 | <5 | <5 | <5 | to | <5 |
| Z-PTE | % | 2.0 | 1.6 | 1.5 | 1.5 | 1.5 | prepare | 1.5 |
| Df | — | 0.0100 | 0.0027 | 0.0020 | 0.0027 | 0.0020 | samples | 0.0032 |
| Df variation | % | 100 | 30 | 20 | 40 | 20 | | 40 |
| rate under | | | | | | | | |
| moisture | | | | | | | | |
| and heat | | | | | | | | |
| Df variation | % | 30 | 18 | 14 | 18 | 15 | | 19 |
| rate under | | | | | | | | |
| heat | | | | | | | | |
| Water | % | 0.86 | 0.41 | 0.35 | 0.50 | 0.36 | | 0.42 |
| absorption | | | | | | | | |
| rate | | | | | | | | |
| PCT | — | XXX | XXX | XXX | XXX | XXX | | XXX |

From Table 1 to Table 3, it can be seen the following:

1. Compared to Comparative Example C1 which uses a mixture of Intermediate 1 and maleic anhydride and Comparative Example C2 which uses a mixture of monoadamantane and BMI-2300, the samples of Examples E1 to E16 which use the polymer represented by Formula (1) of the present disclosure have significant improvements in the following properties: Tg, T300, Z-PTE, Df, Df variation rate under moisture and heat, Df variation rate under heat and water absorption rate. Among them, the samples of Comparative Examples C1 and C2 all have Tg of less than 269° C., while the samples of Examples E1 to E16 all have Tg of greater than or equal to 269° C.; the samples of Comparative Examples C1 and C2 all have T300 of less than 5 minutes, while the samples of Examples E1 to E16 all have T300 of greater than 70 minutes; the samples of Comparative Examples C1 and C2 all have Z-PTE of greater than 1.2%, while the samples of Examples E1 and E16 all have Z-PTE of less than or equal to 1.2%; the samples of Comparative Example C1 and C2 all have Df of greater than 0.0018, while the samples of Examples E1 to E16 all have Df of less than or equal to 0.0018; the samples of Comparative Examples C1 and C2 all have Df variation rate under moisture and heat of greater than 8%, while the samples of Examples E1 to E16 all have Df variation rate under moisture and heat of less than or equal to 8%; the samples of Comparative Examples C1 and C2 all have Df variation rate under heat of greater than 8%, while the samples of Examples E1 to E16 all have Df variation rate under heat of less than or equal to 8%; and the samples of Comparative Examples C1 and C2 all have water absorption rate of greater than 0.25%, while the samples of Examples E1 to E16 all have water absorption rate of less than or equal to 0.25%.

2. Compared to Comparative Examples C3 and C4 which use maleimide resin other than the polymer represented by Formula (1), the samples of Examples E1 to E16 which use the polymer represented by Formula (1) of the present disclosure have significant improvements in the following properties: Tg, T300, Z-PTE, Df, Df variation rate under moisture and heat, Df variation rate under heat and water absorption rate. Among them, The samples of Comparative Examples C3 and C4 all have Tg of less than 269° C., while the samples of Examples E1 to E16 all have Tg of greater than or equal to 269° C.; the samples of Comparative Examples C3 and C4 all have T300 of less than 5 minutes, while the samples of Examples E1 to E16 all have T300 of greater than 70 minutes; the samples of Comparative Examples C3 and C4 all have Z-PTE of greater than 1.2%, while the samples of Examples E1 to E16 all have Z-PTE of less than or equal to 1.2%; the samples of Comparative Examples C3 and C4 all have Df of greater than 0.0018, while the samples of Examples E1 to E16 all have Df of less than or equal to 0.0018; the samples of Comparative Examples C3 and C4 all have Df variation rate under moisture and heat of greater than 8%, while the samples of Examples E1 to E16 all have Df variation rate under moisture and heat of less than or equal to 8%; the samples of Comparative Examples C3 and C4 all have Df variation rate under heat of greater than 8%, while the samples of Examples E1 to E16 all have Df variation rate under heat of less than or equal to 8%; and the samples of Comparative Examples C3 and C4 all have water absorption rate of greater than 0.25%, while the samples of Examples E1 to E16 all have water absorption rate of less than or equal to 0.25%.

3. Compared to Comparative Examples C5 to C7 which use other resins containing an adamantane structure, the samples of Examples E1 to E16 which use the polymer represented by Formula (1) of the present disclosure have significant improvements in the following properties: Tg, T300, Z-PTE, Df, Df variation rate under moisture and heat, Df variation rate under heat and water absorption rate. Among them, Comparative Example C6 cannot be made into a resin composition because the molecular weight of Compound D2 was too large to be dissolved in the solvent, and also cannot be made into a sample; the samples of Comparative Examples C5 and C7 all have Tg of less than 269° C., while the samples of Examples E1 to E16 all have Tg of greater than or equal to 269° C.; the samples of Comparative Examples C5 and C7 all have T300 of less than 5 minutes, while the samples of Examples E1 to E16 all have T300 of greater than 70 minutes; the samples of Comparative Examples C5 and C7 all have Z-PTE of greater than 1.2%, while the samples of Examples E1 to E16 all have Z-PTE of less than or equal to 1.2%; the samples of Comparative Examples C5 and C7 all have Df of greater than 0.0018, while the samples of Examples E1 to E16 all have Df of less than or equal to 0.0018; the samples of Comparative Examples C5 and C7 all have Df variation rate under moisture and heat of greater than 8%, while the samples of Examples E1 to E16 all have Df variation rate under moisture and heat of less than or equal to 8%; the samples of Comparative Examples C5 and C7 all have Df variation rate under heat of greater than 8%, while the samples of Examples E1 to E16 all have Df variation rate under heat of less than or equal to 8%; and the samples of Comparative Examples C5 and C7 all have water absorption rate of greater than 0.25%, while the samples of Examples E1 to E16 all have water absorption rate of less than or equal to 0.25%.

What is claimed is:

1. A polymer, having a structure represented by Formula (1): 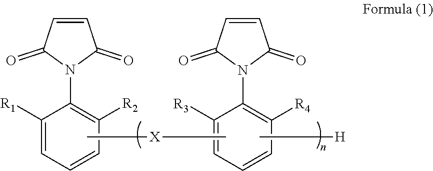
wherein in Formula (1), X is adamantyl group, each of R₁-R₄ is independently hydrogen atom or C1-C3 alkyl group, and n is an integer of 2-50.

2. The polymer of claim 1, wherein X is monoadamantyl group, diamantyl group or polyamantyl group.

3. The polymer of claim 1, wherein the polymer represented by Formula (1) comprises a polymer represented by Formula (1-1), a polymer represented by Formula (1-2), a polymer represented by Formula (1-3) or a combination thereof: 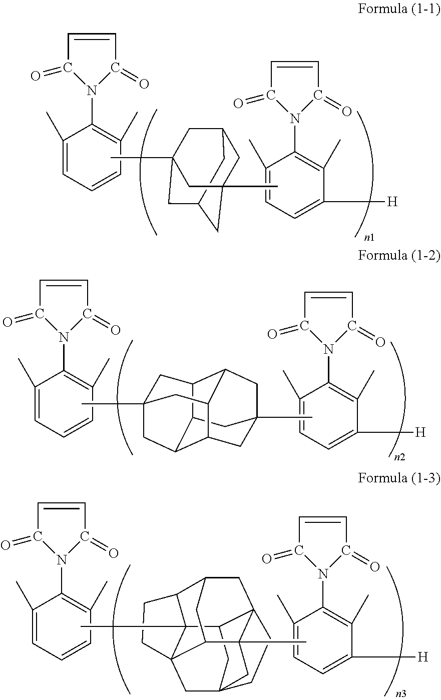
wherein each of n1-n3 is independently an integer of 2-50.

4. The polymer of claim 1, wherein the polymer has a number average molecular weight of 800-17000.

5. A resin composition, comprising:
(A) an unsaturated carbon-carbon double bond-containing polyphenylene ether resin, and
(B) a polymer of claim 1.

6. The resin composition of claim 5, wherein with respect to 100 parts by weight of the unsaturated carbon-carbon double bond-containing polyphenylene ether resin, the amount of the polymer is 10-80 parts by weight.

7. The resin composition of claim 5, wherein with respect to 100 parts by weight of the unsaturated carbon-carbon double bond-containing polyphenylene ether resin, the amount of the polymer is 20-70 parts by weight.

8. The resin composition of claim 5, wherein the unsaturated carbon-carbon double bond-containing polyphenylene ether resin comprises a (meth)acryloyl group-containing polyphenylene ether resin, a vinylbenzyl group-containing polyphenylene ether resin, a vinyl group-containing polyphenylene ether resin or a combination thereof.

9. The resin composition of claim 5, wherein the resin composition further comprises an unsaturated carbon-carbon double bond-containing crosslinking agent, the unsaturated carbon-carbon double bond-containing crosslinking agent is bis(vinylphenyl)ethane, bis(vinylbenzyl)ether, divinylbenzene, divinylnaphthalene, divinylbiphenyl, triallyl isocyanurate, triallyl cyanurate, vinylbenzocyclobutene, trivinyl cyclohexane, diallyl bisphenol A, butadiene, decadiene, octadiene, two or more-functional acrylate or a combination thereof.

10. The resin composition of claim 5, wherein the resin composition further comprises a polyolefin, an organic silicone resin, a benzoxazine resin, an epoxy resin, a polyester resin, a phenol resin, an amine curing agent, a polyamide, a polyimide, a styrene maleic anhydride, a maleimide resin other than the polymer represented by Formula (1), a cyanate ester resin, a maleimide triazine resin or a combination thereof.

11. The resin composition of claim 5, wherein the resin composition further comprises a curing accelerator, a polymerization inhibitor, a flame retardant, an inorganic filler, a surfactant, a coloring agent, a toughening agent, a solvent or a combination thereof.

12. An article, wherein the article is made from a polymer of claim 1, and the article comprises a prepreg, a resin film, a laminate or a printed circuit board.

13. The article of claim 12, wherein the article has one or more of the following properties:
a glass transition temperature as measured by reference to IPC-TM-650 2.4.24.4 of greater than or equal to 269° C.;
a T300 thermal resistance as measured by reference to IPC-TM-650 2.4.24.1 of greater than 70 minutes;
a percent thermal expansion at Z-axis as measured by reference to IPC-TM-650 2.4.24.5 of less than or equal to 1.2%;
a dissipation factor at 10 GHz as measured by reference to JISC2565 of less than or equal to 0.0018;
a dissipation factor variation rate under moisture and heat of less than or equal to 8%, calculated by a dissipation factor of the article placed at room temperature and a dissipation factor of the article placed at a temperature of 85° C. and a relative humidity of 85% for 120 hours respectively at 10 GHz as measured by reference to JISC2565;
a dissipation factor variation rate under heat of less than or equal to 8%, calculated by a dissipation factor of the article placed at room temperature and a dissipation factor of the article placed at a temperature of 125° C. for 120 hours respectively at 10 GHz as measured by reference to JISC2565; and
a water absorption rate as measured by reference to IPC-TM-650 2.6.2.1 and IPC-TM-650 2.6.16.1 of less than or equal to 0.25%.

14. An article, wherein the article is made from a resin composition of claim 5, and the article comprises a prepreg, a resin film, a laminate or a printed circuit board.

15. The article of claim 14, wherein the article has a glass transition temperature as measured by reference to IPC-TM-650 2.4.24.4 of greater than or equal to 269° C.

16. The article of claim 14, wherein the article has a T300 thermal resistance as measured by reference to IPC-TM-650 2.4.24.1 of greater than 70 minutes.

17. The article of claim 14, wherein the article has a percent thermal expansion at Z-axis as measured by reference to IPC-TM-650 2.4.24.5 of less than or equal to 1.2%.

18. The article of claim 14, wherein the article has a dissipation factor at 10 GHz as measured by reference to JISC2565 of less than or equal to 0.0018.

19. The article of claim 14, wherein the article has a dissipation factor variation rate under moisture and heat of less than or equal to 8%, calculated by a dissipation factor of the article placed at room temperature and a dissipation factor of the article placed at a temperature of 85° C. and a relative humidity of 85% for 120 hours respectively at 10 GHz as measured by reference to JISC2565.

20. The article of claim 14, wherein the article has a dissipation factor variation rate under heat of less than or equal to 8%, calculated by a dissipation factor of the article placed at room temperature and a dissipation factor of the article placed at a temperature of 125° C. for 120 hours respectively at 10 GHz as measured by reference to JISC2565.

21. The article of claim 14, wherein the article has a water absorption rate as measured by reference to IPC-TM-650 2.6.2.1 and IPC-TM-650 2.6.16.1 of less than or equal to 0.25%.

22. A preparation method of a polymer of claim 1, comprising: firstly, mixing and reacting an aniline and/or its derivative and a dihalogen-substituted adamantane in a reaction vessel to obtain an intermediate product; and then adding a maleic anhydride to the reaction vessel containing the intermediate product to obtain the polymer.
